(19) United States
(12) Patent Application Publication
(10) Pub. No.: US 2023/0410110 A1
(43) Pub. Date: Dec. 21, 2023

(54) SYSTEMS AND METHODS FOR USE IN LEVERAGING DIFFERENT DATA REPOSITORIES IN DIFFERENT REGIONS

(71) Applicant: MASTERCARD ASIA/PACIFIC PTE. LTD., Singapore (SG)

(72) Inventors: Rajat Maheshwari, Singapore (SG); Matthew Selkirk Driver, Singapore (SG); Karthik Ramanathan, Singapore (SG); Nimit Gulati, Singapore (SG)

(21) Appl. No.: 18/199,758

(22) Filed: May 19, 2023

Related U.S. Application Data
(60) Provisional application No. 63/344,199, filed on May 20, 2022.

(51) Int. Cl. G06Q 20/40

(52) U.S. Cl. CPC G06Q 20/4014

(57) ABSTRACT

Systems and methods are provided for leveraging different data repositories. One example computer-implemented method includes receiving a transfer request for a transfer from a sender in a first region to a recipient in a second region and determining whether the transfer request satisfies a regulation associated with the first and/or second region for information related to the recipient and/or sender. The method also includes submitting an identity request for the recipient and/or sender to an identity network, in response to the transfer request failing to satisfy the regulation, and receiving information regarding the recipient and/or sender, in response to the identity request, from the identity network, where the information includes identifying information for the recipient and/or sender. The method then includes compiling and submitting a transfer request for the transfer to an associated network, whereby the transfer request is submitted to be completed.

### CROSS-REFERENCE TO RELATED APPLICATION

This application claims the benefit of, and priority to, U.S. Provisional Application No. 63/344,199, filed May 20, 2022. The entire disclosure of the above application is incorporated herein by reference.

### FIELD

The present disclosure is generally directed to systems and methods for use in leveraging different data repositories in different regions, and in particular, to leveraging different data repositories in different regions to respond to requests by users disposed in the different regions.

### BACKGROUND

This section provides background information related to the present disclosure which is not necessarily prior art.

Users are known to interact with other users in a variety of different manners. In connection therewith, users may rely on the identities of the other users, and may further assert their own identities as part of the interactions. For example, to an extent, the identity of a user may be presented to a bank as part of opening an account, whereby the bank relies on the identity of the user in opening the account or not. It is further known for users to assert their identities, alone or through presentation of physical documents, or potentially, digital identities, to show or evidence their identities. The relying parties are then permitted to inspect the physical documents, or interact with providers of the digital identities to confirm identity attributes asserted by the users. Further, the identities of the users may be used to identity the users to certain fund transfers, such as, for example, payment account transactions, whereby other entities involved in the transactions may require knowledge of certain identity attributes of the users (e.g., where the users may be the senders or the receivers in the transactions, etc.).

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in leveraging different data repositories in different regions to address requests by users in the different regions;

FIG. 2 is a block diagram of an example computing device that may be used in the system of FIG. 1; and

FIG. 3 illustrates an example method, which may be implemented in connection with the system of FIG. 1, for leveraging different data repositories in different regions.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In connection with a fund transfer, from one user to another (e.g., individual, entity, etc.), certain identity attributes about the user(s) may be required, especially, in instances where the fund transfer is (or includes) a cross-border transfer. When the transfer is initiated, details (or attributes) from the sender (or sender user) about the recipient (or recipient user) of the funds may be limited, and solicited details (or attributes) about the sender may be different than what is required in the recipient's region. What's more, as a fund transfer request passes from institution to institution, or between networks, even the data originally included for the transfer may be omitted, or stripped out, depending on the data required for that particular institution or network. Consequently, absence of such data regarding the sender or recipient may cause the transfers to be delayed or even declined, based on a lack of data, even when the transfers are otherwise compliant with applicable rules or regulations. For example, the transaction may be inhibited until the institution is able to manually contact the participant to secure the required information. Such manual intervention, then, may cause an additional two to three day delay in the fund transfer associated with the transaction. The delay, potential or actual, may cause reluctance or reservation about the technology (by users, relying parties, or other entities), whereby utilization of the same may be reduced.

Uniquely, the systems and methods herein provide for leveraging of identity repositories in connection with fund transfers involving different institutions, whereby limitations of the fund transfer flows through the different institutions and/or networks is solved. In particular, an identity network is disposed as a central resource, which may receive requests from the institutions relating to the fund transfers and respond to the requests with requisite data retrieved from an identity repository in communication therewith. In this manner, responsible parties included in the fund transfers are permitted, through the identity network, to satisfy requirements associated with regulations or protections (e.g., privacy protections, anti-money laundering (AML) rules, on-soil requirements, etc.) without imposing various redundant communication(s) for the fund transfers (e.g., backwards requests for data from senders, forward requests for data from recipients, etc.). As such, the systems and method herein provide for authentication and consent of participants in fund transfers (or other transactions), despite limited information about the participants, through novel, technical communications with relevant repositories, as maintained by on-soil identity providers or IDPs, etc. What's more, identifying and sharing of necessary information to facilitate the interactions (e.g., fund transfers, etc.) herein is directed to the particular information (e.g., user attributes, etc.) necessary for the interactions, whereby extra (and/or unnecessary) information is not identified and/or shared.

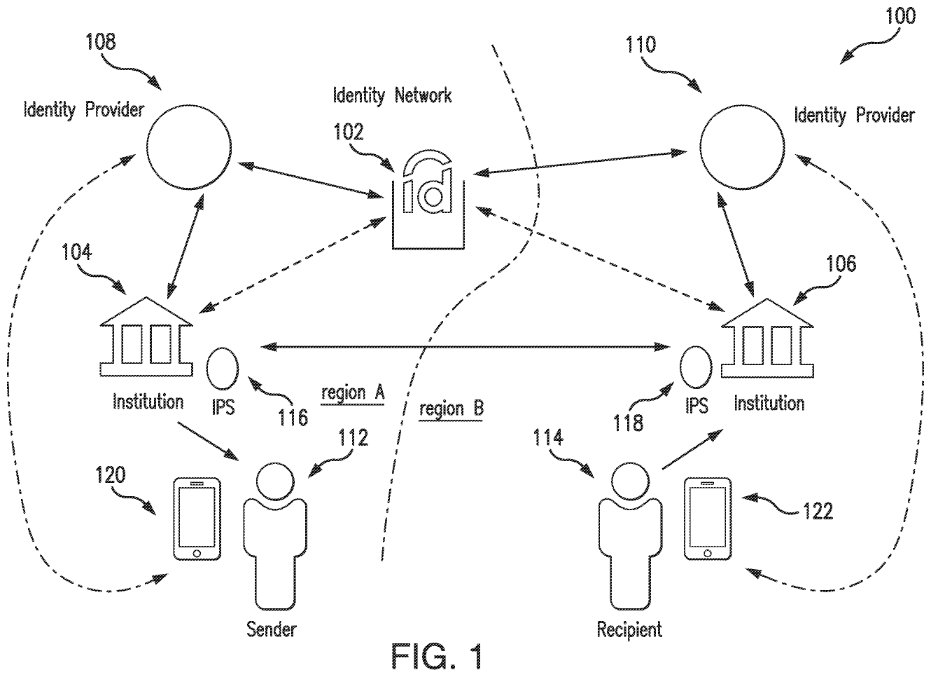

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between identity networks and identification providers, types of processing networks, privacy rules and/or requirements, data sharing rules and/or regulations, etc.

The system 100 generally includes an identity network 102, a first institution 104, a second institution 106, a first identity provider (IDP) 108, and a second IDP 110, each of which is coupled to one or more networks to provide communication therebetween. The network(s) is/are indicated generally by arrowed lines in FIG. 1, and each may include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

In this exemplary embodiment, the identity network 102 is configured to coordinate communication by and between the institutions 104, 106 and the IDPs 108, 110, for example, for data related to fund transfers between a sender 112 and a recipient 114. The identity network 102 may be a standalone entity in the system 100, or it may be integrated, in whole or in part, in another entity, such as, for example, a payment processing network, including the MASTERCARD processing network (or the VISA processing network, the AMERICAN EXPRESS processing network, etc.). In connection therewith, the identity network 102 and/or the IDPs 108, 110 may include applicable agreements (e.g., agreements between regions relating to sharing of information between the regions and/or across borders of the regions, etc.) and/or regulations (e.g., stored in memory of one or more computing devices of the identity network 102, the IDPs 108, 110; etc.) relating to information privacy for various different regions.

The institutions 104, 106 may include, for example, financial institutions, which are configured to issue accounts into which funds are deposited and/or from which funds are transferred. The financial institutions may include banks, investment entities, broker entities, etc. In connection therewith, the sender 112 has an account issued by the institution 104, and the recipient 114 has an account issued by the institution 106, whereby each institution 104, 106 is involved, at least in part, in a transfer to/from the accounts.

In addition, in FIG. 1, the system 100 includes a first instant payment service (IPS) 116 and a second IPS 118. Each of the IPS s 116, 118 is a service, therefore, which configures a computing device therein (and/or associated therewith) to receive, compile and transmit messaging associated with instant or real-time transfers of funds, via an IPS or real-time processing network (not shown), such as, for example, the ZELLE, PAYPAL, or VENMO network. In one or more other embodiments, the IPS s 116, 118 may be replaced by one or more distributed ledger technology (DTL) services, which configures a computing device therein (and/or associated therewith) to receive, compile and transmit messaging associated with ledger transfers of funds, via a ledger network or device (e.g., blockchain ledger, etc.). It should be appreciated that the institution 104 and the IPS 116 may be integrated into the same entity (or computing device(s)), for example, wherein the combination includes a bank configured to transfer funds (e.g., including card transfers, ACH transfers, digital wallet transfers, etc.) via a conventional processing network such as, for example, the MASTERCARD, VISA or AMERICAN EXPRESS processing network, via DTL networks/devices, and/or via an IPS network, etc. The IPS 116 and/or the IPS 118 may include applicable agreements and/or regulations (e.g., stored in memory of one or more computing devices of the IPS 116 and/or the IPS 118, etc.) relating to information privacy for the region(s) in which the IPS 116 and/or IPS 118 are located and/or for other regions.

In addition, it should further be appreciated that the institution 104 and/or the IPS 116 (alone or in combination) are configured to satisfy associated rules and/or regulations and/or regional agreements for transferring funds from the sender 112 to the recipient 114 (e.g., as stored and/or accessed by the IPS 116, etc.). Likewise, the institution 106 and/or the IPS 118 (alone or in combination) are configured to satisfy associated rules and/or regulations and/or region agreements for transferring funds to the recipient 114 from the sender 112 (e.g., as stored and/or accessed by the IPS 116, etc.).

In connection therewith, as shown in FIG. 1, the sender 112 is located in region A, while the recipient 114 is located in region B. Regions A and B are separated by the dotted line in FIG. 1, and the regions may include countries, territories, states, or other different regions, based on government defined boundaries or other boundaries (geographical in nature or not), or other regions, whereby the transfer of funds from region to region may involve or may implicate additional rules and/or regulations (e.g., AML regulations, etc.). In addition in the illustrated embodiment, the institution 104 and the IPS 116 are located in region A, and the institution 106 and the IPS 118 are located in region B, whereby a transfer therebetween is a cross-border, or cross-boundary (across the dotted line) transfer.

In this manner, the system 100 provides the identity network 102, as a solution, which is network agnostic, given the particular implementation, across card, RTP, digital wallet, ACH, DLT, etc., type transfers, to facilitating fund transfers in different regions.

Despite the illustration in FIG. 1, it should be understood that the identity network 102 is located across the multiple regions, whereby a request to the identity network 102 is received in the region in which the request is originated. As such, where the institution 106, for example, submits a request for identifying information, the identity network 102 is located (at least partially) in region B to receive and respond to the request. That said, the identity network 102 may be located in multiple regions, one region, or one or more regions different than an institution in communication therewith (e.g., depending on the particular rules and/or regulations associated with the region or the identifying information in the possession thereof or accessible thereto, etc.).

With continued reference to FIG. 1, the IDPs 108, 110 each include an identity repository specific to the region in which it is located. The identity repository includes, without limitation, personal identifying information (PII) for various users, including the specific users in the region in which the corresponding IDP is located. As such, for example, the sender 112 is registered with the IDP 108, whereby the IDP 108 includes a user profile for the sender 112, which includes, for example, a name, an address, a phone number, government identification numbers (e.g., a social security number, an Aadhaar number, a license number, etc.), biometrics, etc., for the sender 112. The user profile is compiled, by the IDP 108, for example, with participation from the sender 112, the institution 104, etc., and is stored in memory of the IDP 108. The IDP 110 is similarly configured, and further includes an identity repository, which is specific to region B. As such, like the IDP 108, the IDP 110 includes user profiles for relevant users in region B, which includes, in this embodiment, the recipient 114, etc. The user profile for the recipient 114 includes similar information for the recipient 114 to that described above for the sender 112. The IDPs 108, 110 may be standalone entities, or may be associated with or included in a government entity, or associated entity, which is generally configured as a provider of identity verification, etc.

It should be appreciated that various system embodiments may include multiple different institutions, IPS s, and IDPs located in various regions, beyond the two regions illustrated in FIG. 1. The different institutions, IPS s and IDPs would, however, be configured similarly to those included in the system 100, to provide the benefits of the present disclosure thereto (across the various regions). It should further be appreciated that while only one sender and one recipient are illustrated in FIG. 1, other system embodiments would generally include many more senders and recipients located in the same or different regions.

In addition, as shown in FIG. 1, each of the sender 112 and the recipient 114 is associated with a communication device 120, 122, respectively. Each of the communication devices 120, 122 may include, for example, a smartphone, a tablet, a laptop, or other mobile device, or an immobile device, such as, for example, a desktop computing, etc. The communication devices 120, 122 are programmed, for example, to communicate with one or more of the identity network 102 and/or the IDPs 108, 110, in connection with the description described herein. As such, each of the communication devices 120, 122 may include, for example, a web-based application associated with the identity network 102, or the IDPs 108, 110, etc., or each may include one or more messaging applications, such as, for example, a SMS application, an email application, etc., which programs the communication devices 120, 122, as appropriate.

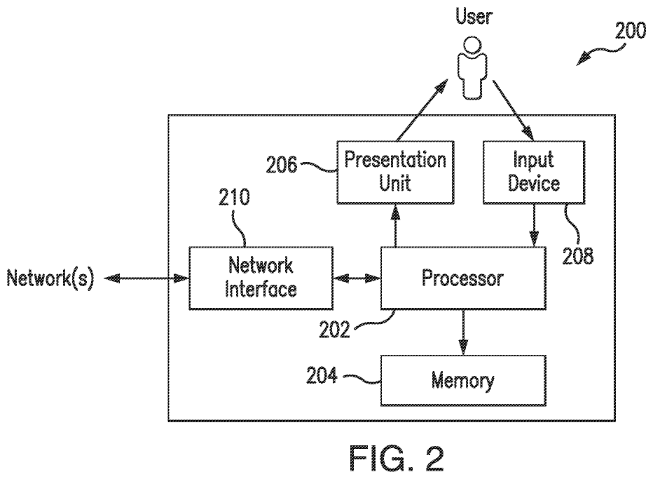

FIG. 2 illustrates an example computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the identity network 102, the institutions 104, 106, the IPS s 116, 118, and the IDPs 108, 110 should be understood to include, or as being implemented or embodied in, one or more computing devices at least partially consistent with the computing device 200, coupled to (and in communication with) one or more of the networks. For example, the identity network 102 may include a network of computing devices consistent with the computing device 200. However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, identifying information and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein (e.g., one or more of the operations of method 300, etc.), whereby upon (or in connection with) performing such operation(s) the computing device 200 may be transformed into a special purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a sender or a recipient of funds in connection with consent, for example, etc. And various interfaces may be displayed at computing device 200, and in particular at presentation unit 206, to display certain information in connection therewith. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) of the computing device 200 such as described below. The input device 208 may include a single input device or multiple input devices. The input device 208 is coupled to (and is in communication with) the processor 202 and may include, for example, one or more of a keyboard, a pointing device, a mouse, a camera, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a WAN adapter, an NFC adapter, a Bluetooth™ adapter, etc.), a mobile network adapter, or other device capable of communicating to one or more different ones of the networks herein and/or with other devices described herein. In some example embodiments, the computing device 200 may include the processor 202 and one or more network interfaces incorporated into or with the processor 202.

Referring again to FIG. 1, the system 100 is configured, generally, for funding (broadly, facilitating) a transfer (or transfers) from the sender 112 to the recipient 114, where the identity network 102 is configured to assimilate, as needed, personal identify information in support of the transfer.

In particular, in response to a request, from the sender 112, to send funds to the recipient 114, the institution 104 is configured to compile a transfer request. In connection therewith, the institution 104 is configured to populate the transfer request with required information regarding the transfer of funds. Specifically, for example, certain information may be required for the sender 112, in order to transfer the funds, especially where the recipient 114 is identified as being located in a different region (e.g., foreign country, etc.). The identifying information for the sender 112 may include a name, email address, account number, etc., and also a government identifier, street address, etc. It should be understood that the sender 112 may include/provide only a portion of the information to be used by the institution 104. In connection therewith (and following due diligence associated with the transfer), the institution 104 may be configured to submit an identity request to the identity network 102 for the sender 112. Upon receipt of the identity request, the identity network 102 is configured to submit the request to the IDP 108, in this example. The IDP 108 is configured to respond to the identity request with identifying information for the sender 112. The identity network 102 is then configured to provide the identifying information to the institution 104. It should be appreciated that the institution 104 may be configured to include the identifying information in the transfer request, or to store the identifying information in connection with the transfer request, but not actually include the identifying information in the transfer request.

In this way, only the specifically needed information to facilitate sending of the funds is identified, collected, and transferred. Additional information about users, often included in physical identity documents, is not provided. For instance, conventionally, where a user is required to provide a driver's license number and address to facilitate a transfer, the user may provide a driver's license to evidence the information. However, in doing so, the user may share additional information not needed for the transfer. As such, by way of the present disclosure, only information specifically needed to facilitate the transfer is identified and shared (e.g., in a privacy preserving manner, etc.).

In addition, the identity network 102 and/or the IDP 108, in the above example, may be configured to seek consent from the sender 112, via the communication device 120, to provide the identifying information in one or more embodiments. Alternatively, the identity network 102 and/or the IDP 108 may be configured to rely on the institution 104 being an issuer of an account to the sender 112 as consent to share identifying information with the institution 104. In at least one embodiment, the institution 104 is configured to solicit contemporaneous consent, via the communication device 120, in connection with the transfer request, and to pass that consent to the identity network 102 and/or IDP 108 along with the identity request. Further, in the above example, upon receiving the identifying information for the sender 112 from the IDP 108, the identity network 102 may retrieve (e.g., from memory, from the IPS 116, from the IPS 118, etc.) applicable regional agreements between region A and region B and/or applicable regulations for region A and/or region B relating to the transfer of identifying information between region A and region B. The identifying information may then be provided by the identity network 102 to the institution 104, for example, when (and, in some embodiments, only when) the assessment confirms that the identifying information can be shared.

Additionally in this example, the transfer request includes identifying information specific to the recipient 114, including, without limitation, a name, email address, phone number, etc. The transfer request may or may not include an account number for the recipient 114. For example, for real-time payments, an alias or a token, such as a phone number, email address or unique name, etc., may be included in the request in lieu of an account number, where the alias/token is known to a specific real-time payment network. As used herein, a token may refer to a series of random characters (e.g., numbers, alpha-numeric characters, etc.) (e.g., 123Adf456, etc.) (potentially computer-generated), while an alias may include a user-selected, familiar username (e.g., john.smith_12345, etc.), etc.

In this example embodiment, the transfer request is for a real-time transfer, whereby the institution 104 is configured to submit the transfer request to the IPS 116. In turn, the IPS 116 is configured to compile a real-time transfer request (e.g., consistent with the ISO 20222 standard, or consistent with an IPS or RTP network standard, etc.) (e.g., an IPS request, etc.), or also ACH standards, and to submit the real-time transfer request to the IPS 118, via the IPS network (not shown). It should be appreciated that in compiling the real-time transfer request, the IPS 116 may be configured to include all or only a portion of the information provided from the institution 104 in the request or additional information, which may account, or not, for regulations and/or rules associated with information privacy, etc., associated with the transfer. That said, it should be appreciated that the transfer request may be compiled consistent with desired standards, for example, depending on the particular transfer and/or requirement associated therewith, etc. For instance, as noted above, the transfer request may be compiled consistent with the ISO 20222 standard, an IPS or RTP network standard, etc. Still other standards may be imposed and or used, as desired, required, etc., including, for example, those associated with open banking so that corresponding application programming interfaces (APIs) may be used to facilitate the requests, and communications associated therewith, as described herein (e.g., the identity request(s), the transfer request(s), the consent request(s), etc.).

In particular in this example, the IPS 116 is configured to determine if sufficient information is known about the recipient 114 in order to proceed with the transfer (e.g., for purposes of due diligence for the transfer, etc.), in view of applicable rules and regulations (in general, and specific to the cross-boundary transfer (i.e., between region A and region B)). When required information is omitted in the request from the institution 104, the IPS 116 is configured to submit an identity request for the information to the identity network 102, where the identity request includes the alias or token specific to the recipient 114 for the IPS network, for example. Consistent with the above, upon receipt of the identity request, the identity network 102 is configured to submit the request to the IDP 110, in this example. The IDP 110 is configured to request consent form the recipient 114, via the communication device 122 (along the dotted communication path). For example, the IDP 110 may be configured to send a SMS message to the recipient 114 (e.g., “Press Y to consent to share your information for a fund transfer, or press N to decline consent,” etc.), or an email message or application-based push message, to seek consent, etc. The recipient 114, in turn, responds with consent, or not. When the recipient 114 responds with consent, the IDP 110 is configured to respond to the identity request by providing identifying information for the recipient 114. The identity network 102, in turn, is then configured to provide the identifying information back to the IPS 116 (e.g., based on the consent from the recipient 114, based on assessment of any agreement between region A and region B to allow cross-border transfer of such data, based on any regulation in place for region A and/or region B relating to the cross-border transfer of such data, etc.), whereby the information is associated with assurances as to its accuracy, for association with the recipient 114, for example, from the identity network 102 and/or the IDP 110, etc. In this manner, the information is moved between regions, potentially, and the IDP 110 and/or the identity network 102 are configured to confirm permission for such movement (e.g., consistent with agreements between region A and region B, etc.) and/or conform the information shared between regions A and B, for example, to suitable and/or applicable regulations for the particular regions A and B associated with the sender 112 and the recipient 114.

In turn, the IPS 116 is configured to confirm that sufficient information is known about the recipient 114 and to then, upon confirmation, compile the identifying information into the real-time transfer request and submit the real-time transfer request to the IPS 118, via the IPS network.

Upon receipt of the real-time transfer request, the IPS 118 is configured to determine if sufficient information is known about the sender 112 in order to proceed with the transfer (e.g., for purposes of due diligence for the transfer, etc.), in view of applicable rules and regulations (in general, and specific to the cross-boundary transfer (i.e., between region A and region B)). When required information is omitted in the real-time transfer request, the IPS 118 is configured to submit an identity request for the information to the identity network 102, where the identity request may include information related to the sender 112 included in the real-time transfer request. Upon receipt of the identity request, the identity network 102 is configured to submit the request to the IDP 108, in this example.

The IDP 108 is configured to request consent form the sender 112, via the communication device 120 (along the dotted communication path). For example, the IDP 110 may be configured to send a SMS message, or an email message, or application-based push message, to the sender 112 in order to seek consent, etc. The sender 112, in turn, responds with consent, or not. When the sender 112 responds with consent, the IDP 108 is configured to respond to the identity request, to the identity network 102, by providing identifying information for the sender 112. The identity network 102, in turn, is then configured to receive the identifying information and provide the identifying information back to the IPS 118 (e.g., based on the consent from the sender 1124, based on assessment of any agreement between region A and region B to allow cross-border transfer of such data, based on any regulation in place for region A and/or region B relating to the cross-border transfer of such data, etc.), whereby the information is associated with assurances as to its accuracy, and association with the sender 112, for example, from the identity network 102 and/or the IDP 108, etc.

The IPS 118 is configured to provide the real-time transfer request, along with any information from the identity network 102, to the institution 106 for the transfer. The institution 106, in turn, is configured to impose the transfer by depositing funds to an account associated with the recipient 114.

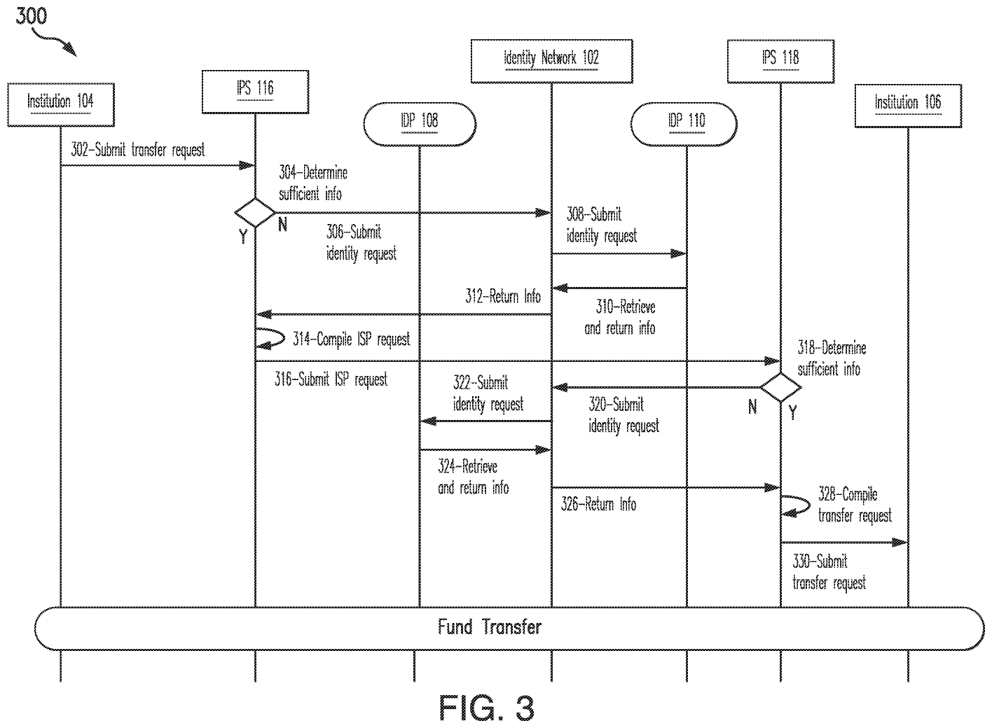

FIG. 3 illustrates an example method 300 for use in leveraging different data repositories in different regions, for example, in connection with a fund transfer between users in the different regions. The example method 300 is described, generally, as implemented via the identity network 102 and the IPS s 116 and 118 of the system 100. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset in the method 300, it should be appreciated that the sender 112 is associated with an account issued by the institution 104, in which the sender 112 has deposited funds. In addition, the recipient 114 is associated with an account issued by the institution 106. Each of the accounts is associated with an account number, and also potentially, an alias or token to identify either the account or the sender/recipient associated with the account. An alias, for example, may include an email address, username, or even a phone number of the sender/recipient. The alias, in general, is associated with the account for the IPS 116 or the IPS 118, whereby the account is identifiable in connection with real-time or instant fund transfers therethrough.

In the embodiment herein, the sender 112 decides to initiate a fund transfer to the recipient 114, or more particularly, from the sender's account to the recipient's account. In connection therewith, the sender 112 identifies himself/herself, a source account for the funds, an amount of the transfer, and the recipient 114 and/or the recipient's account, to the institution 104. In turn, at 302, the institution 104 submits a transfer request to the IPS 116, whereby the transfer is an instant or real-time transfer via the IPS network. It should be appreciated that the institution 104 may facilitate the transfer otherwise, i.e., not an instant or real-time transfer, whereby the institution 104 may perform subsequent method steps described herein directly, in lieu of the IPS 116 performing the steps.

As indicated, in this example, the transfer request includes a name of the sender 112, an account identifier (e.g., number, alias, etc.) for the account, a name of the recipient 114, and the amount. In addition, the request may include an identifier of the account of the recipient 114, such as, for example, an alias or token. Upon receipt of the request, the IPS 116 determines, at 304, whether the request includes sufficient information, based on, for example, rules and/or regulation for transferring funds, in general (i.e., between two parties, etc.) or specifically, from the region A to the region B, and/or to/from a foreign region, etc. An example AML rule/regulation for cross-border wire transfers of funds in Thailand exceeding 50,000 baht may include, for instance, a requirement that both the ordering and the recipient institutions 104, 106 obtain information about the origin of the funds, as well as both the sender 112 and the recipient 114.

When the IPS 116 determines that there is insufficient information for the recipient 114 (e.g., missing recipient last name, etc.), the IPS 116 submits, at 306, an identity request to the identity network 102. The identity network, in turn, at 308, submits the identity request to the IDP 110, located in region B (i.e., the same region as the recipient 114) (e.g., whereby the IDP 110 and/or IPS 118 are/is identified based on the region B in which the recipient 114 is currently located and/or the region B in which the institution 106 is located, etc.). The identity request may include a name, or partial name, and an account alias or token, etc., for the recipient 114 or other information available for the recipient 114, to permit the IDP 110 to identify the recipient 114, and more specifically, a user profile in the repository of the IDP 110 for the recipient 114. In some embodiments, upon receiving the identity request, the IDP 110 may assess applicable agreements between region A and region B relating to sharing of the information identified in the identity request between the regions A, B and/or regulations relating to the sharing of such information between the regions A, B. In doing so, the IDP 110 may retrieve the applicable agreement(s) and/or regulation(s) from memory, and then assess the same based on the requested information.

At 310, the IDP 110 then retrieves the specific requested information from the user profile for the recipient 114 (e.g., when acceptable to do so, etc.), and returns the information to the identity network 102. It should be appreciated that, optionally, prior to retrieving the specific requested information, the IDP 110 may also seek consent from the recipient 114, via the communication device 122 (e.g., via SMS message, email, application notification, etc.), and then only continue when the consent is received. In some examples, the sender 112 and/or the recipient 114 may provide an automatic consent for certain types and/or amounts of fund transfers.

The identity network 102 returns, at 312, the information to the IPS 116. In some embodiments, upon receiving the requested information from the IDP 110, the identity network 102 may assess applicable agreements between region A and region B relating to sharing of the information received from the IDP 110 between the regions A, B and/or regulations relating to the sharing of such information between the regions A, B. In doing so, the identity network 102 may retrieve the applicable agreement(s) and/or regulation(s) from memory, and then assess the same based on the information.

Similar to the above, when the IPS 116 determines that there is insufficient information for the sender 112 (e.g., missing sender last name, etc.), the IPS 116 may submit an identity request to the identity network 102. The identity network, in turn, may submit the identity request to the IDP 108, located in region A (i.e., the same region as the sender 112). In general, in the above, the IDP 108 and/or 110 and/or the IPS 116 and/or 118 is/are identified based on which region (e.g., country, etc.) the funds associated with the fund transfer are coming from or where the funds are sent.

In response to the returned information (or when the transfer request includes sufficient information), at 314, the IPS 116 compiles the IPS request, which reflects the transfer and includes the information related to the sender 112 and the information related to the recipient 114 (including the information received from the identity network 102). The IPS 116 submits, at 316, the IPS request to the IPS 118, via the IPS network.

When the IPS 118 receives the IPS request, the IPS 118 determine, at 318, whether the IPS request includes all the necessary or required information to complete the transfer, i.e., whether there is sufficient information.

When the IPS 118 determines that there is insufficient information for the sender 112 (e.g., missing recipient last name, etc.), the IPS 116 submits, at 320, an identity request to the identity network 102. The identity network, in turn, at 322, submits the identity request to the IDP 108, located in region A (i.e., the same region as the sender 112 and/or the institution 104 (whereby the IDP 108 is identified based on the sender 112 and/or the institution being in region A)). The identity request may include a name, or partial name, and an account alias or token, etc., for the sender 112 or other information available for the sender 112, to permit the IDP 108 to identify the sender 112, and more specifically, a user profile in the repository of the IDP 108 for the sender 112. At 324, the IDP 108 retrieves the specific requested information from the user profile for the sender 112, and then returns the information to the identity network 102. It should be appreciated that, optionally, prior to retrieving the specific requested information, the IDP 108 may seek consent from the sender 112, via the communication device 120 (e.g., via SMS message, email, application notification, etc.), and then only continue when the consent is received. Conversely, the sender 112 may provide an automatic consent for certain types and/or amounts of fund transfers. When the information is returned, the identity network 102 returns, at 326, the information to the IPS 118. In some embodiments, upon receiving the information from the IDP 108, the identity network 102 may assess applicable agreements between region A and region B relating to sharing of the information identified in the identity request between the regions A, B and/or regulations relating to the sharing of such information between the regions A, B. In doing so, the identity network 102 may retrieve the applicable agreement(s) and/or regulation(s) from memory, and then assess the same based on the requested information, prior to returning the information to the IPS 118.

In response to the returned information (or when the transfer request includes sufficient information), the IPS 116 compiles, at 328, a transfer request for the transfer and submits, at 330, the transfer request to the institution 106. The transfer request reflects the intended transfer, and also, includes the information related to the sender 112 (including the information received via the identity network 102) and the information related to the recipient 114 (including the information received via the identity network 102). The institution 106 then proceeds with the transaction and reports the transfer to the institution 104 (e.g., via the IPS network, etc.), as is conventional.

In some examples, the communications described in the system 100 and method 300 above, again (e.g., the communications associated with the various requests, etc.), may be facilitated through, or completed through, open banking and/or APIs associated therewith (e.g., via or as a standard protocol for open banking, etc.). For instance, data flows between the IDPs 108, 110 and the institutions 104, 106 may be done, performed, etc. via standardized API specifications (e.g., where available, where defined as part of OB frameworks, etc.). Such standardization may expedite adoption of the systems and/or methods herein by additional institutions and may also standardize user experiences thereacross (e.g., for users to provide consent to share data in connection with completing transfer requests as described herein, etc.). In addition, use of opening banking and/or associated APIs may help provide an added AML or sanctions-screening layer on top of the fund transfers described herein to thereby improve overall success rates for such transfers (and corresponding risk assurances to the transfers). Further, use of opening banking rails in connection with data sharing described herein may open fund transfer interactions to licensed institutions (e.g., wallet institutions, etc.) other than banks, thereby allowing, enabling, etc. such institutions to provide fund transfer solutions to users. In this way, additional data may be made available in the systems and methods herein to facilitate, address, etc. the different requests for data described above, via open banking rails if available in market.

In view of the above, the systems and methods herein provides a cross-border solution, in which information related to specific participants that is conventionally subject to restrictions is made accessible, to reduce or eliminate friction associated with fund transfers, via participant requests for additional information through an identity network coupled in communication with multiple on-soil repositories in the form of identity providers or IDPs. In particular, the information is requested and retrieved to complete transfer requests in the context of regulations limiting the institutions/services involved in the transfers (e.g., related to know-you-customer (KYC), anti-money laundering, etc.). In this manner, when layered on to instant or real-time payments, or other payment rails, the identity network provides efficient procession of data associated with the transfers (even when entities permit data fall-off as the requests are presented through the procession), which rely on verified data from IDPs to fill in for omitted or dropped information (or to verify included data).

In addition, as described above, the systems and methods herein provide requested point data in response to requests, whereby only the specifically needed point data is provided between regions (e.g., to facilitated fund transfers, etc.). In this way, additional data often linked to or associated with the requested point data is not provided. For instance, conventionally, where a user is required to provide a driver's license number and address to facilitate a fund transfer, the user may provide a driver's license to evidence the information. However, in doing so, the user may share additional information not needed for the transfer. As such, by way of the systems and methods herein, only data specifically needed/requested is identified and shared between the regions (e.g., in a privacy preserving manner, etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the following operations: (a) receiving a transfer request indicative of a transfer from a sender in a first region to a recipient in a second region; (b) determining whether the transfer request satisfies at least one regulation associated with the first and/or second region for information related to the recipient and/or sender; (c) submitting an identity request for the recipient and/or sender to an identity network, in response to determining that the transfer request fails to satisfy the at least one regulation, whereby the identity network seeks information regarding the recipient and/or sender from an identity provider (IDP) located in the second and/or first region; (d) receiving information regarding the recipient and/or sender, in response to the identity request, from the identity network, the information including identifying information for the recipient and/or sender from the IDP; and (e) compiling and submitting a transfer request for the transfer to an associated network, thereby proceeding with the transfer from the sender to the recipient.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” as well as the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in leveraging different data repositories in different regions, the method comprising:
receiving, by a computing device, a transfer request indicative of a transfer from a sender in a first region to a recipient in a second region, which is different from the first region;
determining, by the computing device, whether the transfer request satisfies at least one regulation associated with the first region and/or the second region for information related to the recipient and/or the sender;
in response to determining that the transfer request fails to satisfy the at least one regulation, submitting, by the computing device, an identity request for the recipient and/or the sender to an identity network, whereby the identity network seeks information regarding the recipient and/or the sender from an identity provider (IDP) located in the second region and/or the first region;
receiving, by the computing device, information regarding the recipient and/or the sender, in response to the identity request, from the identity network, the information including identifying information for the recipient and/or the sender from the IDP; and
based on the received information, compiling and submitting, by the computing device, a transfer request for the transfer to an associated network, thereby proceeding with the transfer from the sender to the recipient.

2. The computer-implemented method of claim 1, wherein the transfer request for the transfer includes a request for a real-time fund transfer from the sender to the recipient; and/or
wherein the associated network includes a real-time payment network.

3. The computer-implemented method of claim 1, wherein the at least one regulation includes minimum identifying information for the recipient and/or the sender; and
wherein the transfer request lacks at least a portion of the minimum identifying information for the recipient and/or the sender.

4. The computer-implemented method of claim 1, wherein the first region and the second region are different countries.

5. The computer-implemented method of claim 1, wherein the identity request includes identifying information included in the transfer request; and
wherein the received information regarding the recipient and/or the sender includes at least one of a first name, a last name, and/or an address of the recipient and/or the sender.

6. The computer-implemented method of claim 5, wherein compiling the transfer request for the transfer includes compiling the transfer request to include the at least one of a first name, a last name, and/or an address of the recipient and/or the sender.

7. The computer-implemented method of claim 6, wherein the transfer request is received via a real-time-payment network; and
wherein the associated network includes an institution associated with an account of the recipient.

8. A system for use in leveraging different data repositories in different regions, the system comprising:
an instant payment service (IPS) computing device coupled in communication with an identity network, the IPS computing device located in a first region and configured to
receive a transfer request indicative of a transfer from a sender in the first region to a recipient in a second region, which is different than the first region;
determine whether the transfer request satisfies at least one regulation associated with the first region and/or the second region for information related to the recipient and/or the sender;
when the transfer request fails to satisfy the at least one regulation, submit an identity request for the recipient and/or the sender to the identity network, which is configured to seek information regarding the recipient and/or the sender from an identity provider (IDP) located in the second region;
receive information regarding the recipient and/or the sender, from the identity network, which is in response to the identity request, the information including identifying information for the recipient and/or the sender from the IDP; and
compile and submit, to an associated network, a transfer request for the transfer, the transfer request including at least a portion of the received information.

9. The system of claim 8, wherein the transfer request for the transfer includes a request for a real-time fund transfer from the sender to the recipient; and
wherein the associated network includes a second instant payment service (IPS) computing device located in the second region.

10. The system of claim 8, wherein the at least one regulation includes minimum identifying information for the recipient and/or the sender; and
wherein the transfer request lacks at least a portion of the minimum identifying information for the recipient and/or the sender.

11. The system of claim 8, wherein the first region and the second region are different countries.

12. The system of claim 11, wherein the identity request includes identifying information included in the transfer request; and
wherein the received information includes at least one of a first name, a last name, and/or an address of the recipient.

13. The system of claim 12, wherein compiling the transfer request for the transfer includes compiling the transfer request to include the at least one of a first name, a last name, and/or an address of the recipient.

14. A non-transitory computer-readable storage medium comprising executable instructions for use in leveraging different data repositories, which when executed by at least one processor of a computing device, cause the at least one processor to:
receive a transfer request indicative of a transfer from a sender in a first region to a recipient in a second region, which is different than the first region;
determine whether the transfer request satisfies at least one regulation associated with the first region and/or the second region for information related to the recipient and/or the sender;
when the transfer request fails to satisfy the at least one regulation, submit an identity request for the recipient and/or the sender to an identity network, whereby the identity network seeks information regarding the recipient from an identity provider (IDP) located in the first region and/or the second region;
receive information regarding the recipient and/or the sender, from the identity network, which is in response to the identity request, the information including identifying information for the recipient from the IDP; and
compile and submit, to an associated network, a transfer request for the transfer, the transfer request including at least a portion of the received information.

15. The non-transitory computer-readable storage medium of claim 14, wherein the transfer request for the transfer includes a request for a real-time fund transfer from the sender to the recipient; and
wherein the first and second regions include different countries.

16. The non-transitory computer-readable storage medium of claim 14, wherein the at least one regulation includes minimum identifying information for the recipient and/or the sender; and
wherein the transfer request lacks at least a portion of the minimum identifying information for the recipient and/or the sender.

17. The non-transitory computer-readable storage medium of claim 14, wherein the identity provider (IDP) located in the second region; and
wherein the received information regards the recipient;
wherein the identity request includes identifying information included in the transfer request; and
wherein the received information regarding the recipient and/or the sender includes at least one of a first name, a last name, and/or an address of the recipient.

18. The non-transitory computer-readable storage medium of claim 14, wherein the identity provider (IDP) located in the first region; and
wherein the received information regards the sender;
wherein the executable instructions when executed by at least one processor of a computing device, cause the at least one processor to: receive the transfer request from an instant payment service (IPS) computing device located in the first region;
wherein the identity request includes identifying information included in the transfer request; and
wherein the received information regarding the sender includes at least one of a first name, a last name, and/or an address of the sender.

19. The non-transitory computer-readable storage medium of claim 14, wherein the transfer request includes a transfer request for a real-time fund transfer from the sender to the recipient, received via a real-time-payment network; and
wherein the associated network includes an institution associated with an account of the recipient.
